(19) United States
(12) Patent Application Publication
(10) Pub. No.: US 2006/0220522 A1
(43) Pub. Date: Oct. 5, 2006

(54) Image display device

(76) Inventors: Hiroyuki Tachihara, Ooamishirasato (JP); Hiroshi Sasaki, Mobara (JP); Kouichi Shouji, Chosei (JP); Shigemi Hirasawa, Chiba (JP); Yuuichi Kijima, Chosei (JP)

Correspondence Address: Christopher E. Chalsen;Milbank, Tweed, Hadley & McCloy LLP, 1 Chase Manhattan Plaza, New York, NY, 10005-1413, US

(21) Appl. No.: 11/294,083

(22) Filed: Dec. 5, 2005

(30) Foreign Application Priority Data
Dec. 6, 2004 (JP) 2004-352829

(51) Int. Cl. H01J 63/04

(52) U.S. Cl. 313/495

(57) ABSTRACT

By forming chamfered portions on corner portions of a spacer, a contact area between the spacer and a fixing material is enlarged. Side surfaces of the spacer including the chamfered portions are embedded into the inside of the fixing material and hence, an adhesion area of the spacer with the fixing material is enlarged thus enhancing an adhesion strength. As a result, a fixing strength of the spacers which hold a space between a back panel and a face panel in vacuum is enhanced.

### CROSS-REFERENCE TO RELATED APPLICATION

The present application claims priority from Japanese application JP2004-352829 filed on Dec. 6, 2004, the content of which is hereby incorporated by reference into this application

### BACKGROUND OF THE INVENTION

1. Field of the Invention

The present invention relates to a self-luminous flat panel type image display device which makes use of the emission of electrons into a vacuum. Particularly, the present invention relates to an image display device which arranges spacers between a back panel which includes electron sources and a face panel which includes a plurality of phosphor layers.

2. Description of the Related Art

A color cathode ray tube has been popularly used conventionally as an excellent display device which exhibits high brightness and high definition. However, along with the realization of high image quality of recent information processing device and television broadcasting, there has been a strong demand for a planar image display device which is light-weighted and requires a small space for installation while ensuring the excellent properties such as high brightness and high definition.

As typical examples of such a planar image display device, a liquid crystal display device, a plasma display device or the like has been put into practice. Further, particularly with respect to the planar display device which can realize the high brightness, various types of panel display devices including an electron emission type display device which makes use of emission of electrons from electron sources, a field emission type display device, and an organic EL display which is characterized by low power consumption are expected to be put into practice in near future. Here, the plasma display device, the electron emission type display device or the organic EL display device which requires no auxiliary illumination light sources is referred to as a self-luminous planar display device.

Among these self-luminous planar display devices, with respect to the electron emission type display device, the display device which has the cone-shaped electron emission structure proposed by C. A. Spindt, a display device which has the metal-insulator-metal (MIM) type electron emission structure, a display device which has the electron emission structure making use of an electron emission phenomenon based on a quantum tunneling effect (also referred to as surface conductive type electron sources), and a display device which makes use of an electron emission phenomenon of a diamond film, a graphite film, nanotubes or the like as represented by carbon nanotubes and the like have been known.

A display panel which constitutes a field emission type display device which constitutes one example of the self-luminous planar display device includes a back panel which forms first electrodes having field emission type electron sources (for example, cathode electrodes, signal electrodes, data electrodes) and second electrodes which constitute control electrodes (for example, gate electrodes, scanning electrodes) on an inner surface thereof, and a face panel which faces the back panel and forms phosphor layers of a plurality of colors and third electrodes (for example, anode electrodes, anodes) on an inner surface thereof. The face panel is made of a light-transmitting glass material which is preferably glass.

Further, an envelope is formed by sandwiching a frame between both panels. The inside of the envelope which is formed of the back panel, the face panel and the frame is held in vacuum. With respect to the back panel, on a back substrate which is suitably made of an insulation material such as glass, alumina or the like, a plurality of first electrodes which extend in the first direction and are arranged in parallel in the second direction which intersects the first direction and include a large number of electron sources, and second electrodes which extend in the second direction and are arranged in parallel in the first direction are formed.

The electron sources are formed on intersecting portions of the first electrodes and the second electrodes, and an electron emission quantity from the electron source (including turning on and off of the electron emission) is controlled based on a potential difference between the first electrode and the second electrode. The emitted electrons are accelerated by a high voltage applied to the third electrodes formed on the face panel and, at the same time, impinge on phosphor layers formed on the face panel thus exciting the phosphor layers so as to allow the phosphor layers to emit lights of colors corresponding to light emitting characteristic of the phosphor layers.

The individual electron source forms a pair with the corresponding phosphor layer and constitutes a unit pixel. Usually, one pixel (also referred to as color pixel or pixel) is constituted of unit pixels of three colors consisting of red (R), green (G) and blue (B). Here, in case of the color pixel, the unit pixel is also referred to as a sub pixel.

To peripheral portions of the back panel and the face panel, a frame is fixed using a sealing material such as frit glass. The degree of vacuum in the inside of a glass hermetic container which is formed of the back panel, the face panel and the frame is held at 10⁻⁵ to 10⁻⁷ Torr (1.33×10⁻⁵ to 1.33×10⁻⁷ hpc), for example. In the panel having a large display screen size, a plurality of spacers (also referred to as spacers or insulation walls) are interposed between the back panel and the face panel thus ensuring a given gap between both panels. The spacers are formed of an insulation material made of glass or ceramics or a material having some conductivity in a thin plate shape, and are, usually, mounted in an erected manner at a position for every plurality of pixels where the spacer does not impede an operation of the pixel.

In mounting the spacers which ensure the given gap between the back panel and the face panel, various studies have been made with respect to the structure which prevents a trajectory of an electron beam from being bent by the charging up of the spacers, the structure which prevents the spacers from being damaged by enhancing the arrangement property of the spacer, the structure which prevents the discharge and the like.

For example, as an example of a means which prevents the chipping of a corner portion of a spacer, for example, Japanese Patent Laid-open 2003-317652 discloses the constitution in which by setting flat-portion-ratios of lengths of respective flat portions on a top surface of a spacer with respect to a width of a cross-sectional shape to 40 to 90%, preferably 50 to 80%, it is possible to easily mount the spacers on a panel glass substrate in an erected manner and, at the same time, it is possible to prevent the chipping of the spacer.

FIG. 8 is an enlarged cross-sectional view of a support frame portion of the conventional image display device. In the currently available image display device, with respect to a back substrate SUB1 which constitutes a back panel and a face substrate SUB2 which constitutes a face panel in a state that both substrates SUB1, SUB2 face each other in an opposed manner, a gap defined between both substrates is held by a support frame MFL and gap holding members (hereinafter referred to as spacers) SPC. Both upper and lower end portions of the spacers SPC are respectively fixed to the back substrate SUB1 and the face substrate SUB2 by baking a frit glass paste (hereinafter referred to as paste) FGP. Here, a group of electron emission elements which is formed on a surface of the back substrate SUB1 and image forming members and the like formed on an inner surface of the face substrate are omitted from the drawing.

The spacers of the image display device having such a constitution are assembled due to means shown in FIG. 9A to FIG. 9C. The spacer SPC is embedded into the paste FGP applied to the back substrate SUB1, and the paste FGP is hardened to temporarily fix the spacer SPC. In arranging the spacer SPC on the paste FGP, as shown in FIG. 9B, the spacer SPC is pushed into the inside of the paste FGP having a fixed thickness. Then, as shown in FIG. 9C, it is necessary to increase an adhesive strength by forming an adhesive surface to which the paste FGP is adhered not only on a peripheral portion of a lower end surface of the spacer SPC but also on a portion of a side surface of the spacer SPC. Here, although not shown in the drawing, the same goes for an upper end surface of the spacer SPC which is adhered to an inner surface of the face substrate SUB2 shown in FIG. 8.

### SUMMARY OF THE INVENTION

However, since a bottom surface of the spacer SPC is formed of a single plane, as shown in FIG. 9B, the insertion resistance which the spacer SPC receives when the spacer SPC is inserted into the paste FGP is large. Accordingly, the spacer SPC cannot be sufficiently inserted into the paste FGP, or a gap is formed between the spacer SPC and the paste FGP. Further, such a constitution becomes a cause which generates the deformation such as the inclined insertion of the spacer SPC or the like. Further, as shown in FIG. 9C, when the spacer SPC is inserted in the inside of the paste FGP, an adhesion quantity of the paste to the side surface of the spacer SPC is small.

As a result, there have been following drawbacks. That is, it is difficult to hold and fix the spacers SPC between the substrates in a state that the displacement and the inclination of the spacers SPC are not generated. Further, it is difficult to maintain the parallelism between both substrates. Further, it is difficult to ensure a sufficient panel strength.

Further, there has been also drawbacks that the spacers SPC are damaged and electrodes and the like formed on the inner surface of the substrate are damaged by the damaged spacers. Still further, there exists a possibility that cracks or leaks are generated in a hermetic sealing portion by adding a fixing-by-heating step of the spacers SPC. There has been a demand for overcoming these drawbacks.

Further, in fixing the spacers SPC to the back substrate SUB1 and the face substrate SUB2, frit glass which is substantially equal to the frit glass of the hermetic sealing material is used. With respect to the crystallized frit glass, the crystallization progresses due to heating for a long time and hence, physical values such as a thermal expansion coefficient or the like are changed whereby cracks are generated due to an impact or the like, and the hermetic sealing property is damaged thus generating leaks.

Further, amorphous frit glass may be softened by reheating. In this case, due to the softening of the amorphous frit glass, the position of the spacer which is once fixed may be displaced or the spacer may be inclined. Accordingly, it is difficult to hold and fix the spacers at given positions with high accuracy. Further, because of the deflection of the substrate, it is also difficult to hold the parallelism of both substrates and to ensure the panel strength. Further, there exists a possibility that the spacers are damaged.

Accordingly, the present invention has been made to overcome the above-mentioned conventional drawbacks. It is an object of the present invention to provide an excellent image display device which can realize the large sizing of a display size and a high-quality display by ensuring a panel strength while holding the parallelism between both substrates by ensuring the fixing of the spacers and, at the same time, can possess a prolonged life time.

The image display device according to the present invention can allow a spacer to ensure a large contact area with respect to a fixing material by forming a chamfered portion to a corner portion of the spacer. According to the present invention, a side surface of the spacer including the chamfered portion is inserted into the inside of the fixing material and hence, the spacer is fixed to the fixing material with a large adhesive area whereby the drawbacks of the related art can be overcome.

Further, according to another image display device of the present invention, by forming the chamfered portion on the respective corner portions of both upper and lower end surfaces of the spacer, the spacer can ensure the large contact area with respect to the fixing material. The present invention can overcome the drawbacks of the related art by allowing a side surface of the spacer including the chamfered portions to be pushed into the inside of the fixing material thus ensuring a large adhesion area of the side surface to the fixing material.

Further, another image display device according to the present invention can ensure the large contact area with respect to the fixing material by forming the chamfered portion into a flat surface. The present invention can overcome the drawbacks of the related art by increasing the contact area between the spacer and the fixing material.

Further, another image display device according to the present invention can ensure the large contact area with respect to the fixing material by forming the chamfered portion into a curved surface. The present invention can overcome the drawbacks of the related art by increasing the contact area between the spacer and the fixing material.

Here, the present invention is not limited to the above-mentioned respective constitutions and constitutions described in embodiments described later and various modifications can be made without departing from the technical concept of the present invention.

According to the present invention, by forming the chamfered portion to respective corner portions of at least one end surface of the spacer, the spacer can ensure a large contact area with respect to a fixing material. According to the present invention, it is possible to increase an adhesive strength of the spacer with at least one of a back substrate and a face substrate and hence, the reliability of fixing by adhesion can be ensured whereby it is possible to obtain extremely excellent advantageous effects such as the holding of a gap between the back substrate and the face substrate at a desired value in cooperation with a frame, the enhancement of a mechanical strength of a panel, the enhancement of impact resistance and the like.

Further, according to the present invention, by forming the chamfered portion on respective corner portions of the upper and lower end surfaces of the spacer, the spacer can ensure a large contact area with respect to a fixing material. According to the present invention, it is possible to increase an adhesive strength of the spacer with a back substrate and a face substrate and hence, the reliability of fixing by adhesion can be ensured whereby it is possible to obtain extremely excellent advantageous effects such as the holding of a gap between the back substrate and the face substrate at a desired value in cooperation with a frame, the enhancement of a mechanical strength of a panel, the enhancement of impact resistance, the realization of large-sizing of a display size and a high-quality display, the realization of an image display device having a prolonged life time and the like.

Further, according to the present invention, by forming a shape of the chamfered portion into a flat surface or a curved surface, a contact area of the spacer with the fixing material can be increased and hence, it is possible to obtain extremely excellent advantageous effects such as the increase of an adhesive strength of the spacer with the back substrate and the face substrate, the assurance of the reliability of fixing by adhesion and the like.

### BRIEF DESCRIPTION OF THE DRAWINGS

FIG. 1 is a schematic plan view showing the constitution according to an embodiment 1 of an image display device according to the present invention;

FIG. 2 is an enlarged cross-sectional view of an essential part taken along a line I-I in FIG. 1;

FIG. 3 is an enlarged cross-sectional view of an essential part showing the spacer mounting structure in FIG. 2;

FIG. 4A and FIG. 4B are views showing the constitution of the spacer of the image display device according to the present invention, wherein FIG. 4A is an enlarged perspective view and FIG. 4B is an enlarged cross-sectional view of an essential part;

FIG. 5A, FIG. 5B and FIG. 5C are views for explaining steps in which the spacers shown in FIG. 4A and FIG. 4B are fixed to a panel board;

FIG. 6A and FIG. 6B are views showing the constitution according to an embodiment 2 of the spacer of an image display device of the present invention, wherein FIG. 6A is an enlarged perspective view and FIG. 6B is an enlarged cross-sectional view of an essential part in FIG. 6A;

FIG. 7A and FIG. 7B are views for explaining one example of the whole structure of the image display device according to the present invention, wherein FIG. 7A is a perspective view with a part broken away and FIG. 7B is a cross-sectional view taken along a line II-II in FIG. 7A;

FIG. 8 is an enlarged cross-sectional view of an essential part showing the constitution of a conventional image display device;

FIG. 9A, FIG. 9B and FIG. 9C are views for explaining steps in which conventional spacers are fixed and arranged on a panel substrate;

FIG. 10 is an enlarged perspective view of an end portion of the spacer used in the image display device according to the present invention; and

FIG. 11 is a perspective view of the back substrate of the image display device according to the present invention.

### DESCRIPTION OF THE PREFERRED EMBODIMENTS

### Embodiment 1

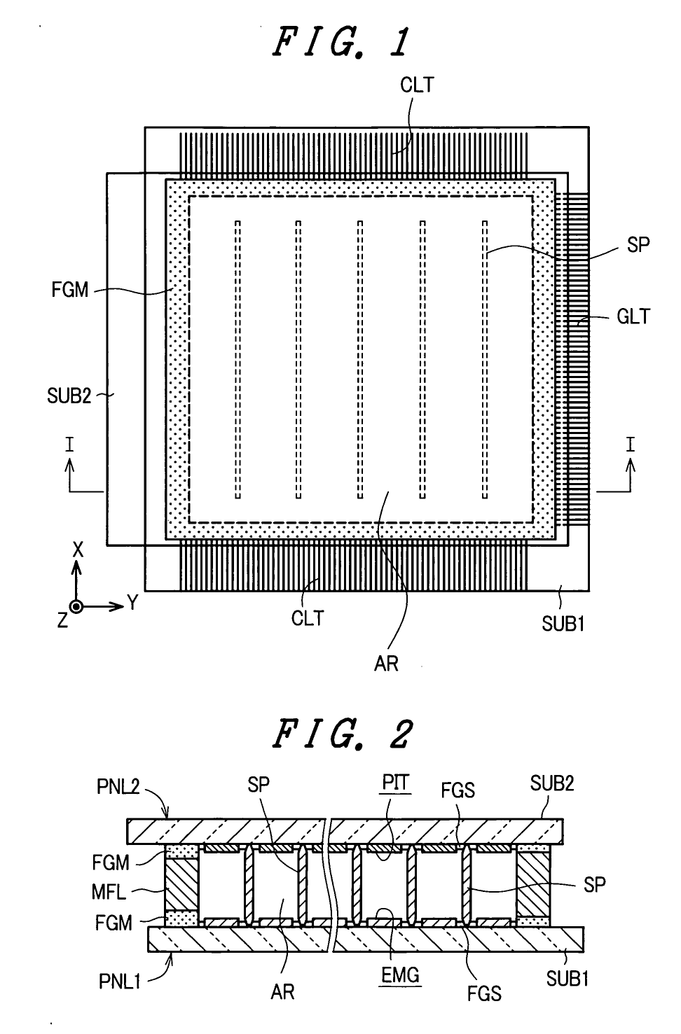

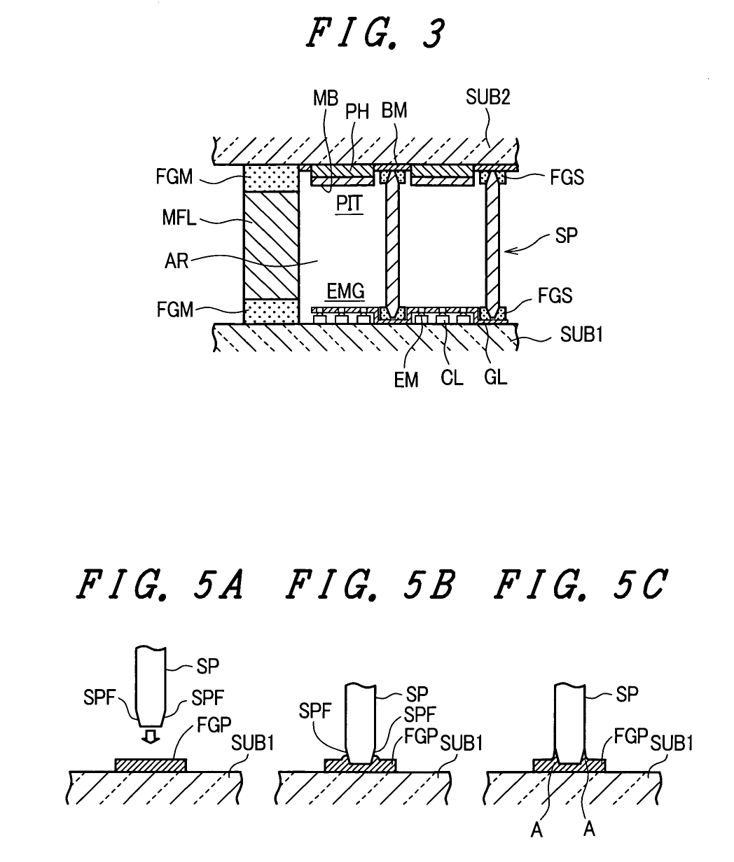

FIG. 1 to FIG. 3 show an embodiment 1 of an image display device according to the present invention, wherein FIG. 1 is a schematic plan view having general constitution as viewed from a face panel side, FIG. 2 is a schematic cross-sectional view taken along a line I-I in FIG. 1 and FIG. 3 is an enlarged cross-sectional view of an essential part in FIG. 2.

In these drawings, symbol SUB1 indicates a back substrate which constitutes a back panel PNL1, symbol SUB2 indicates a face substrate which constitutes a face panel PNL2, symbol MFL indicates a frame, symbol SP indicates gap holding members (spacers), symbol EMG indicates a group of electron emission elements, symbol CL indicates cathode lines, symbol CLT indicates cathode line lead terminals, symbol EM indicates electron sources, symbol GL indicates gate lines, symbol GLT indicates gate line lead terminals, symbol PIT indicates an image forming member, symbol PH indicates phosphor layers, symbol MB indicates a metal back film (anode), symbol BM indicates a black matrix film, symbol FGM indicates a sealing material, symbol FGS indicates a fixing material, and symbol AR indicates an image display region.

In such a constitution, the back substrate SUB1 is preferably formed of a glass plate or a ceramic plate made of alumina or the like. That is, the back substrate SUB1 is formed of an insulation substrate having a plate thickness of several mm, for example, approximately 3 mm. Further, the face substrate SUB2 is preferably formed of a transparent glass plate or the like, that is, is formed of a light transmitting substrate having a plate thickness of several mm, for example, approximately 3 mm.

Further, the frame MFL which is arranged in a peripheral portion between the back substrate SUB1 and the face substrate SUB2 and also functions as an outer frame is formed of a glass plate, a molded body made of frit glass or the like. The frame MFL is fixed between the back substrate SUB1 and the face substrate SUB2 by way of the sealing material FGM thus holding a distance between the back substrate SUB1 and the face substrate SUB2 at a given size, for example, approximately 3 mm. Here, in this embodiment, frit glass containing lead oxide (PbO), for example is used as the sealing material FGM.

The plate-like spacers SP which are provided for holding the distance or the gap between the face panel and the back panel in the pixel display region are formed by cutting a glass sheet or a ceramics sheet made of alumina or the like having a plate thickness of approximately 0.1 mm, for example, such that the spacers SP have a height of approximately 3 mm, wherein chamfered portions are integrally formed on respective corner portions of both of upper and lower end surfaces of the spacer SP. A cross-sectional shape of the spacer is formed in a longitudinal octagonal shape. Here, the spacers SP may be formed of a molded body made of a rare earth containing glass material.

Further, symbol EMG indicates the group of electron emission elements, wherein the group of electron emission elements EMG is constituted of cathode electrodes, electron sources EM and gate electrodes, wherein the group of electron emission elements are arranged on the back substrate SUB1 at a given interval. Cathode electrodes are connected with cathode lines CL, while the gate electrodes (scanning electrodes) are connected with gate lines (scanning lines) GL. A plurality of cathode lines CL are formed on an inner surface of the back substrate SUB1 in a state that the cathode lines CL extend in one direction (x direction) and are arranged in parallel in another direction (y direction). Terminal portions of the cathode lines CL are divided along two sides of the back substrate SUB1 as the cathode line lead terminals CLT and are pulled out to the outside of a hermetic sealing portion. The cathode electrodes are formed by a vapor deposition method or the like, for example. Alternatively, the cathode electrodes are formed such that a silver paste which is produced by mixing a low-melting-point glass which exhibits the insulation property to conductive silver particles having a particle size of approximately 1 to 5Ξm, for example is printed to form a thick film and the film is baked at the temperature of approximately 600° C., for example. Here, the respective electrodes and the respective lines may be formed on the same layers respectively.

Further, the gate lines GL are arranged above the cathode lines CL in a state that the gate signal lines GL are insulated from the cathode lines CL, while end portions of the gate lines GL are pulled out to the outside of the hermetic sealing portion which constitutes another one side of the back substrate SUB1 as gate line lead terminal GLT.

Further, the electron sources EM may be formed of a metal-insulator-metal (MIM) type electron emission element, a surface conductive type electron emission structure element, a diamond film, a graphite film or carbon nanotubes. In this embodiment, as a method for forming electron sources, for example, a carbon nanotube paste is printed on surfaces of the cathode electrodes which are printed with a large film thickness and are baked and, thereafter, the paste is baked at the temperature of approximately 590° C. in vacuum.

Further, symbol PIT indicates the image forming member, wherein the image forming member PIT is formed of a phosphor layer PH, a metal back film MB which is applied to the phosphor layer PH, and the black matrix (BM) film BM, and is arranged on an inner surface of the face substrate SUB2.

In such a constitution, electrons emitted from the electron sources EM are controlled by electron passing holes of the gate electrodes GL to which a gate voltage of approximately 100V is applied, the electrons pass through the electron passing holes, advance to the image forming members PIT to which an anode voltage of several KV to 10 and several KV is applied, pass through the metal back film (anode) MB, and impinge on the phosphor layers PH thus allowing the phosphor layers PH to emit light whereby a desired display is performed on a viewing image screen. Further, in a region surrounded by cathode lines CL and gate lines GL, a cathode electrode and a gate electrode are arranged to form a unit pixel. These pixels are arranged in a matrix array to form a pixel display region AR. In general, a color pixel is formed of three unit pixels of red (R), green (G) and blue (B)

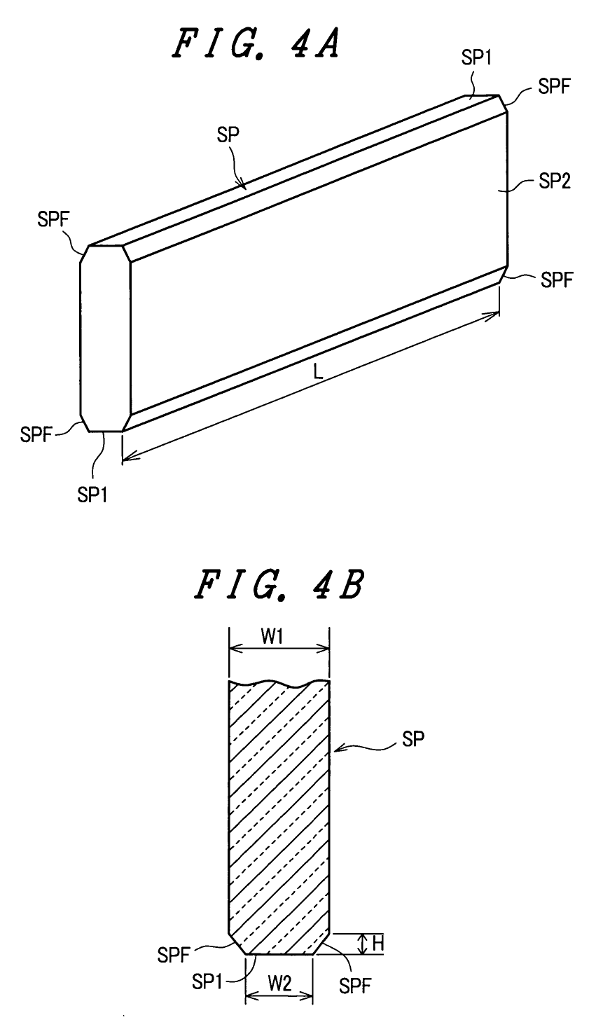

Next, the structure of the above-mentioned spacer SP is explained in detail. FIG. 4A and FIG. 4B are views for explaining the constitution of the above-mentioned spacer SP, wherein FIG. 4A is a perspective view and FIG. 4B is an enlarged cross-sectional view. As shown in FIG. 4A and FIG. 4B, with respect to the spacer SP, chamfered portions SPF are integrally formed on respective corner portions of upper and lower end surfaces SP1 which are brought into contact with the back substrate SUB1 side and the face substrate SUB2 side shown in FIG. 3. The chamfered portions SPF are flat surfaces which intersect both end surfaces SP1 and side surfaces SP2 of the spacer SP. Here, a spacer base body is formed by cutting a glass plate or a ceramics plate made of alumina having a height of approximately 3 mm. The chamfered portions SPF are formed by applying polishing or abrasion to respective corner portions of the spacer base material.

Further, the spacer SP is configured as shown in FIG. 4B such that a length L thereof is approximately 100 mm, a width W1 at a center portion thereof is approximately 100 μm, a height H of the chamfered portion SPF is approximately 5 μm, a width W2 of upper and lower end surfaces falls within a range of approximately 20 μm to 80 μm, and a height thereof is 3 mm.

The spacers SP are sandwiched between the back substrate SUB1 and the face substrate SUB2 as shown in FIG. 1. The spacers SP are arranged substantially perpendicular to the surface of the substrate in the inside of the image display region AR. A plurality of spacers SP are arranged at a given pitch interval while allowing the length direction thereof aligned in one direction (x direction) thus forming a row, and a plurality of these rows are arranged in parallel at a given pitch interval in another direction (y direction) which intersects the above-mentioned one direction. The spacers SP are fixed and arranged at given portions between the back substrate SUB1 and the face substrate SUB2 by way of the fixing material FGS which contains a conductive component, for example, as shown in FIG. 3, between the gate lines GL which is formed on the back substrate SUB1 and the black matrix film BM formed on the inner surface of the face substrate SUB2 by way of the fixing material FGS using the fixing structure which adopts the fixing by melting. Further, the spacers SP hold the distance between the back substrate SUB1 and the face substrate SUB2 at a given size in a cooperative manner with the frame MFL. Here, in this embodiment, as the fixing material FGS, frit glass containing lead oxide (PbO), for example, which differs from the above-mentioned sealing material FGM in a melting fixing temperature is used. The fixing material FGS is obtained by heating and hardening a paste-like fixing material FGP.

FIG. 5A, FIG. 5B and FIG. 5C are cross-sectional views of an essential part for explaining steps in which the above-mentioned spacer SP is fixed to and arranged on the panel substrate. As shown in FIG. 5A, on the paste FGP which is applied to the back substrate SUB1, for example, the spacer SP which is provided with the chamfered portions SPF having a flat surface is arranged on respective corner portions of the lower end portion. Next, as shown in FIG. 5B, the spacer SP is embedded into the paste FGP. Since the chamfered portions SPF are formed on the spacer SP, in pushing the spacer into the inside of the paste FGP having a fixed thickness, it is possible to decrease the push-in resistance. Further, an adhesion area between the spacer and the paste can be increased and hence, the spacer can be temporarily fixed with a large contact area. By allowing the spacer to pass through a succeeding heating step, the paste FGP is hardened so as to fix the spacer. FIG. 5C shows a shape of a fixed portion after the heating step. The fixing material is brought into contact with the spacer SP with a wide area which is formed of not only the lower end surface of the spacer SP but also of the chamfered portions SPF and side surface portions. At a portion indicated by a point A in the inside of the paste FGP, the volume of paste is increased so as to fix the spacer SP. Here, an adhesion height of the fixing material FG up to the side surface of the spacer SP is approximately 30 μm when a height H of the chamfered portion SPF is approximately 5 μm. The chamfered portions SPF are covered with the paste FGP. When the paste FPG hardened, it becomes a fixing material FG. The spacer SP is embedded into the fixing material FG. The fixing material covers the spacer while getting over the chamfered portions. That is, an end portion of the fixing material gets over the chamfered portions and is positioned on the facing substrate side. Further, the fixing material is adhered to the whole region of the chamfered portions of the spacer.

In the spacer SP having such a constitution, by forming the chamfered portions SPF on respective corner portions of the lower end surface, the fixing strength between the back substrate SUB1 and the spacer SP is increased and hence, the load resistance is increased whereby the impact resistance is largely enhanced. Further, by forming the chamfered portions SPF on respective corner portions of the lower end surface of the spacer SP, the lower end portion of the spacer SP is easily pushed into the inside of the applied paste FGP and the paste FGP is brought into contact with the chamfered portions SPF having a wide area and hence, the mounting step of the spacers SP can be simplified and, at the same time, the spacers can be mounted with high accuracy whereby a yield rate is improved and the productivity can be enhanced.

Here, in this embodiment, although the explanation has been made with respect to the case in which the lower end portion of the spacer SP is fixed by adhesion to the back substrate SUB1, when the upper end portion of the spacer SP is fixed by adhesion to the inner surface of the face substrate SUB2, the upper end portion of the spacer SP is fixed using completely equal adhesion structure as shown in FIG. 5A, FIG. 5B and FIG. 5C.

### Embodiment 2

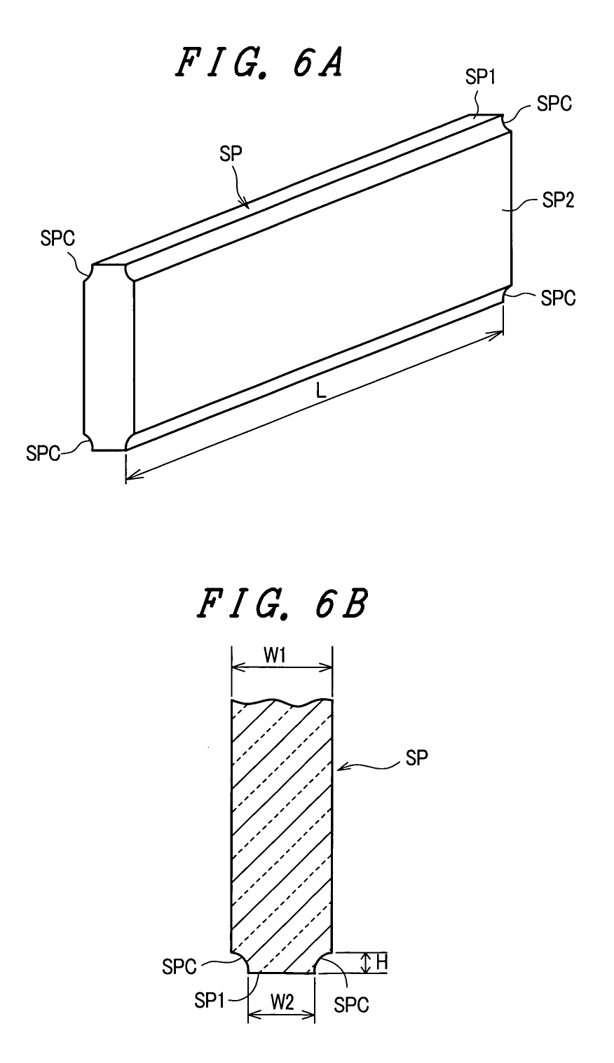

Here, in the above-mentioned embodiment, the explanation has been made with respect to the case in which the chamfered portions SPF having the flat surface are formed on the respective corner portions of both of upper and lower end portions of the spacer SP. However, the present invention is not limited to such a case. FIG. 6A and FIG. 6B are views for explaining the constitution of the above-mentioned spacer SP, wherein FIG. 6A is a perspective view and FIG. 6B is an enlarged cross-sectional view. With the use of the spacer SP which forms chamfered portions SPC having a curved surface on respective corner portions of both of upper and lower end surfaces, it is also possible to obtain advantageous effects similar to the above-mentioned advantageous effects. By forming the curved surface of the chamfered portion in a concave shape, a paste enters a recessed portion. As a result, a quantity of a fixing material is increased thus realizing the stable fixing of the spacer SP.

Here, in the above-mentioned embodiment, the explanation has been made with respect to the case in which the frit glass which contains lead oxide (PBO), for example, is used as the fixing material FGS which fixes the spacer SP. However, it is needless to say that the present invention is not limited to such a case and the substantially equal advantageous effects can be obtained using other various kinds of frit glass.

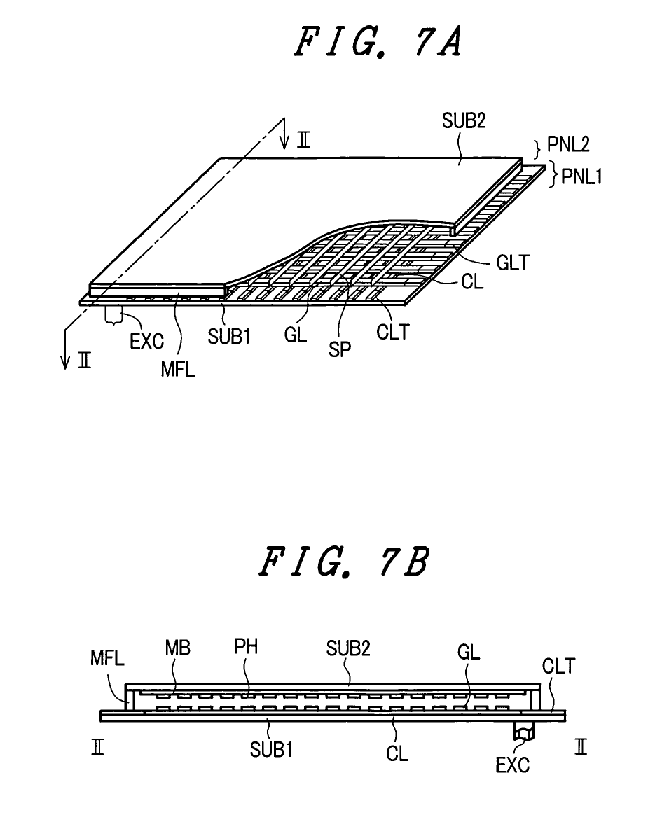

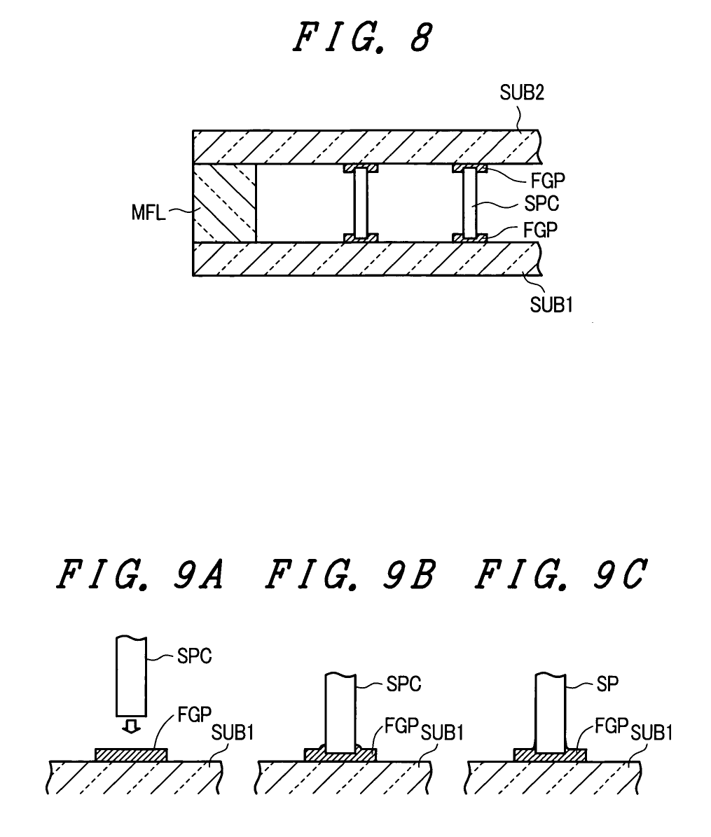

FIG. 7A and FIG. 7B are views for explaining one example in which the image display device according to the present invention is applied to a 32-inch-type image display device, wherein FIG. 7A is a perspective view and FIG. 7B is a cross-sectional view taken along a line II-II in FIG. 7A. On the inner surface of the back substrate SUB1 which constitutes a back panel PNL1, the cathode lines CL which constitute data lines and the gate lines GL which constitute scanning lines are formed, while electron sources EM shown in FIG. 3 are formed on the intersecting portions of the cathode lines CL and the gate lines GL. The cathode-line lead lines CLT not shown in the drawings are formed on end portions of the cathode lines CL, while gate-line lead lines GLT are formed on end portions of the gate lines GL.

On the inner surface of the face substrate SUB2 which constitutes the face panel PNL2, the black matrix film not shown in the drawing, the metal back film (anode) MB, the phosphor layers PH and the like are formed. The back substrate SUB1 which constitutes the back panel PNL1 and the face substrate SUB2 which constitutes the face panel PNL2 are laminated to each other while interposing the frame MFL between peripheral portions thereof using the sealing material. Here, to hold the lamination gap to a given value, between the back substrate SUB1 and the face substrate SUB2, as has been explained in the above-mentioned embodiment, the spacers SP which form the chamfered portions SPC on respective corner portions of both of upper and lower end surfaces are mounted in an erected manner. Here, the spacers SP are arranged at a rate of approximately 6 pieces in the lateral direction and at a rate of approximately 20 pieces in the longitudinal direction with respect to the 32-inch-type image display panel.

Here, an inner space which is hermetically sealed by the back panel PNL1, the face panel PNL2 and the frame body MFL, is held in a given vacuum state by evacuating the inner space from an exhaust pipe EXC formed on a portion of the back panel PNL1.

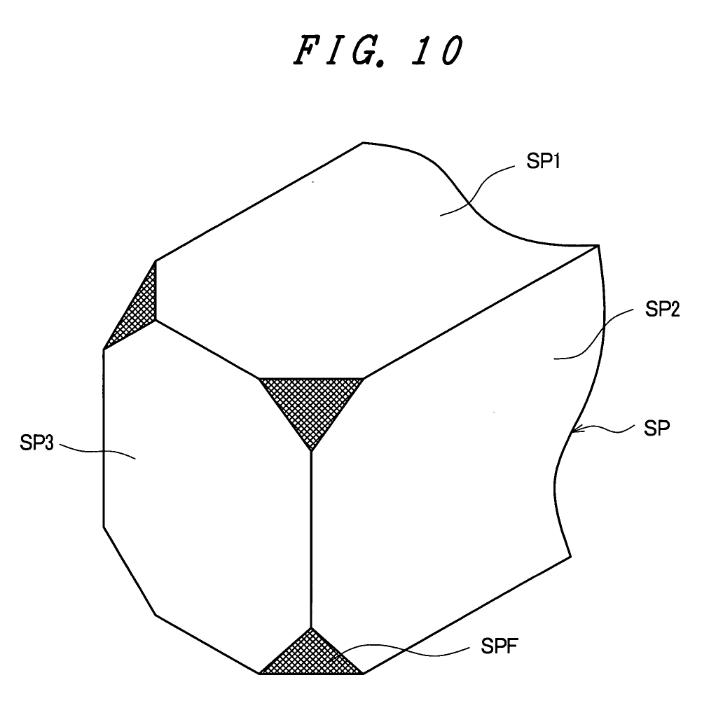

FIG. 10 is an enlarged perspective view of the end portion of the spacer SP used in the image display device of the present invention. In fixing the spacer SP by adhesion using only the longitudinal end portion of the spacer SP, the chamfered portion SPF is formed on the corner portion where three surfaces SP1, SP2, SP3 which constitute the spacer SP abut to each other. By forming the chamfered portion SPF on the adhesion portion, it is possible to surely fix the spacer SP.

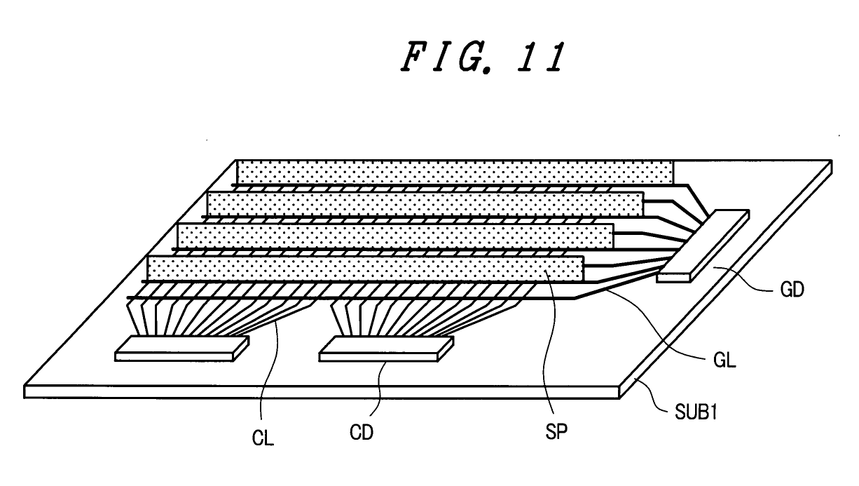

FIG. 11 is a perspective view of the back substrate SUB1 of the image display device according to the present invention. On the back substrate SUB1, a gate drive circuit GD which is connected with the gate lines GL and a cathode drive circuit CD which is connected with the cathode lines CL are arranged. Here, the gate drive circuit GD and the cathode drive circuit CD are mounted after evacuating the gas in the inside of the inner space and sealing the inner space. The spacers SP are arranged in parallel with the gate lines GL. Since an interval between the neighboring gate lines GL can be set larger than an interval between the neighboring cathode lines CL, the arrangement of the spacers SP in parallel with the gate lines GL can be performed more simply than the arrangement of the spacers SP in parallel to the cathode lines CL.

Further, since it is possible to make a width of the gate lines GL wider than a width of the cathode lines CL, the arrangement of the spacers SP on the gate lines GL becomes simpler than the arrangement of the spacers SP on the cathode lines CL. Further, by arranging the spacers SP parallel to the gate lines GL, it is possible to increase a width of the fixing material thus enabling the strong holding of the spacers SP.

Further, although the explanation has been made by taking the structure which uses the carbon nanotubes as the electron sources as an example, the present invention is not limited to such structure, and it is possible to obtain advantageous effects completely equal to the above-mentioned advantageous effects by applying the present invention to a self-luminous FPD which uses the above-mentioned various electron sources.

What is claimed is:

1. An image display device comprising:
a face substrate having an image display region which includes anodes and phosphor layers;
a back substrate having a plurality of cathode lines and a plurality of electron sources which are connected to the cathode lines, the back substrate being arranged to face the face substrate in an opposed manner with a given distance therebetween,
a frame which is arranged between the face substrate and the back substrate outside the image display region, the frame being fixed to the face substrate and the back substrate by a sealing material; and
a plurality of spacers being interposed between the face substrate and the back substrate within the image display region, the spacers being fixed between both the substrates by way of a fixing material, wherein
a chamfered portion is formed on corner portions of the spacer, and
an adhesive height of the fixing material is larger than a height of the chamfered portion.

2. An image display device according to claim 1, wherein the chamfered portion is formed on respective corner portions on both of upper and lower end portions of the spacer.

3. An image display device according to claim 1 or claim 2, wherein the chamfered portion is formed in a flat shape.

4. An image display device according to claim 1 or claim 2, wherein the chamfered portion is formed in a curved shape.

5. An image display device comprising:
a face substrate having an image display region which includes anodes and phosphor layers;
a back substrate having a plurality of cathode lines and a plurality of electron sources which are connected to the cathode lines, the back substrate being arranged to face the face substrate in an opposed manner with a given distance therebetween,
a frame which is arranged between the face substrate and the back substrate outside the image display region, the frame being fixed to the face substrate and the back substrate by a sealing material; and
a plurality of spacers being interposed between the face substrate and the back substrate within the image display region, the spacers being fixed to the substrate by way of a fixing material, wherein
a chamfered portion is formed on corner portions of the spacer and the chamfered portion is formed in a flat shape, and
the spacer is embedded into the fixing material.
